(19) United States
(12) Patent Application Publication
(10) Pub. No.: US 2026/0178489 A1
(43) Pub. Date: Jun. 25, 2026

(54) METHOD AND APPARATUS FOR METADATA CACHING

(71) Applicant: Dell Products L.P., Round Rock, TX (US)

(72) Inventors: Rong Yu, West Roxbury, MA (US); Lixin Pang, Needham, MA (US)

(73) Assignee: Dell Products L.P., Round Rock, TX (US)

(21) Appl. No.: 18/986,806

(22) Filed: Dec. 19, 2024

(51) Int. Cl. G06F 12/0802

(52) U.S. Cl. CPC G06F 12/0802

(57) ABSTRACT

A method for use in a storage system including a plurality of nodes, the method including: receiving, at a given one of the plurality of nodes, a read request; classifying the read request as either a random read request or a sequential read request; when the read request is classified as a random read request, storing a given track that includes first metadata associated with the read request in a local cache of the given node; when the read request is classified as a sequential read request, storing a page that includes the first metadata in a global memory of the storage system, the page including a plurality of tracks, the plurality of tracks including the given track; and retrieving the first metadata from the local cache or the global memory of the storage system, and using the first metadata to complete the read request.

### BACKGROUND

A distributed storage system may include a plurality of storage devices (e.g., storage arrays) to provide data storage to a plurality of nodes. The plurality of storage devices and the plurality of nodes may be situated in the same physical location, or in one or more physically remote locations. The plurality of nodes may be coupled to the storage devices by a high-speed interconnect, such as a switch fabric.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to aspects of the disclosure, a method for use in a storage system including a plurality of nodes, the method comprising: receiving, at a given one of the plurality of nodes, a read request; classifying the read request as either a random read request or a sequential read request; when the read request is classified as a random read request, storing a given track that includes first metadata associated with the read request in a local cache of the given node; when the read request is classified as a sequential read request, storing a page that includes the first metadata in a global memory of the storage system, the page including a plurality of tracks, the plurality of tracks including the given track; and retrieving the first metadata from the local cache or the global memory of the storage system, and using the first metadata to complete the read request, wherein the local cache of the given node is implemented by using a physical memory hardware of the given node, and wherein the global memory includes a plurality of global memory portions that are part of a same address space, each global memory portion being implemented by using physical memory hardware that is part of a different one of the plurality of nodes in the storage system.

According to aspects of the disclosure, a storage processor is provided, comprising: a physical memory hardware; and at least one processor that is operatively coupled to the physical memory hardware, the at least one processor being configured to perform the operations of: receiving a read request; classifying the read request as either a random read request or a sequential read request; when the read request is classified as a random read request, storing a given track that includes first metadata associated with the read request in a local cache; when the read request is classified as a sequential read request, storing a page that includes the first metadata in a global memory of a storage system, the page including a plurality of tracks, the plurality of tracks including the given track; and retrieving the first metadata from the local cache or the global memory, and using the first metadata to complete the read request, wherein the local cache is implemented by using the physical memory hardware, and wherein the global memory includes a plurality of global memory portions that are part of a same address space, each global memory portion being implemented by using physical memory hardware that is part of a different one of a plurality of storage processors in the storage system.

According to aspects of the disclosure, a non-transitory computer-readable medium storing one or more process-executable instructions, which when executed by at least one processor of a of a given node cause the given node to perform the operations of: receiving a read request; classifying the read request as either a random read request or a sequential read request; when the read request is classified as a random read request, storing a given track that includes first metadata associated with the read request in a local cache of the given node; when the read request is classified as a sequential read request, storing a page that includes the first metadata in a global memory of a storage system of which the given node is part, the page including a plurality of tracks, the plurality of tracks including the given track; and retrieving the first metadata from the local cache or the global memory of the storage system, and using the first metadata to complete the read request, wherein the local cache of the given node is implemented by using a physical memory hardware of the given node, and wherein the global memory includes a plurality of global memory portions that are part of a same address space, each global memory portion being implemented by using physical memory hardware that is part of a different one of a plurality of nodes in the storage system, the plurality of nodes including the given node.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1A is a diagram of an example of a system, according to aspects of the disclosure;

FIG. 1B is a diagram of an example of a storage system, according to aspects of the disclosure;

FIG. 1C is a diagram of an example of different units of data storage, according to aspects of the disclosure;

FIG. 2 is a flowchart of an example of a process, according to aspects of the disclosure;

FIG. 3 is a flowchart of an example of a process, according to aspects of the disclosure;

FIG. 4 is a diagram of an example of a storage processor, according to aspects of the disclosure;

FIG. 5 is a flowchart of an example of a process, according to aspects of the disclosure;

FIG. 6 is a schematic diagram illustrating an example of a method for performing one of the steps in the process of FIG. 5; and

FIG. 7 is a schematic diagram illustrating an example of a method for performing another one of the steps in the process of FIG. 5.

### DETAILED DESCRIPTION

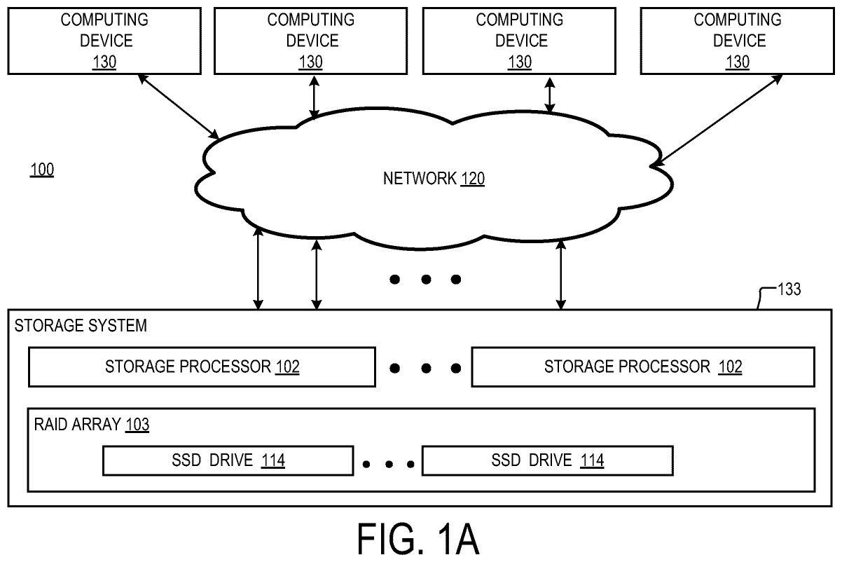

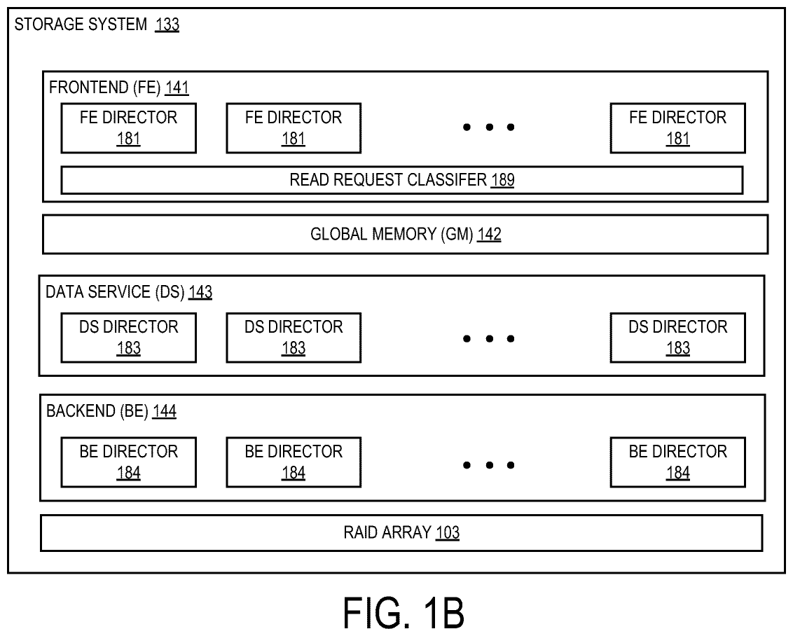

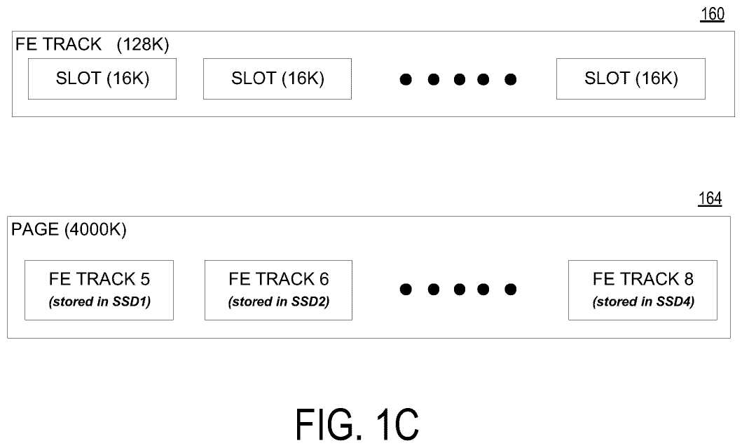

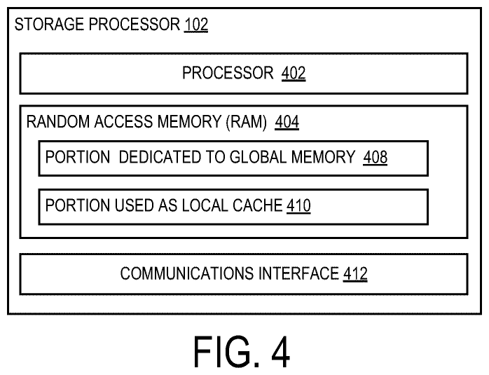

FIG. 1A is a diagram of an example of a system 100, according to aspects of the disclosure. As illustrated, system 100 may include a storage system 133 coupled to a plurality of computing devices 130 via a communications network 120. Each of the computing devices 130 may include a smartphone, a desktop, a server, a laptop, and/or any other device that might be used by a user to store and retrieve data from the storage system 133. The communications network 120 may include one or more of the Internet, a local area network (LAN), a wide area network (WAN), an InfiniBand network, a mobile data network, etc. Storage system 133 may include a plurality of storage processors 102 and a plurality of storage devices 114. In some implementations, each of the storage devices 114 may include a Solid-State Drive (SSD), a Non-Volatile Memory Express (NVME) device, a hard disk, and/or any other suitable type of storage device. According to the present example, the storage devices are arranged in a RAID array 103. An example of one possible implementation of the storage processors 102 is discussed further below with respect to FIG. 4. Each of the storage processors 102 may be configured to receive I/O requests from the computing devices 130 and execute the received requests by reading or writing data to the RAID array 103.

FIG. 1B is a diagram illustrating an example of one possible configuration of storage system 133, according to aspects of the disclosure. As illustrated, the storage system 133 may include a frontend (FE) 141, a global memory (GM) 142, a data service (DS) 143, and a backend (BE) 144. FE 141 may be comprised of one or more FE directors 181. Each FE director 181 may include one or more processes that are executed on a respective one of the storage processors 102. DS 143 may be comprised of one or more DS directors 183. Each DS director 183 may include one or more processes that are executed on a respective one of the storage processors 102. BE 144 may be comprised of one or more BE directors 184. Each BE director 184 may include one or more processes that are executed on a respective one of the storage processors 102. GM 142 includes a shared memory space that is used by storage system 133 for caching data. GM 142 may include a plurality of memory portions that are united in the same address space, wherein each of the plurality of memory portions is part of the volatile memory (e.g., DRAM) of a different respective one of the storage processors 102. GM 142 (or the address space of GM 142) may be accessible to each of the storage processors 102 in the storage system 133. In other words, each of the storage processors 102 in storage system 133 may access the memory portion (which is dedicated to GM 142) of any other storage processor 102 in the storage system 133. Further information of the configuration of storage system 133 that that is shown in FIG. 1B can be found in U.S. patent application Ser. No. 18/820,867, entitled “INTELLIGENT RELOCATION DESTAGE,” filed on Aug. 30, 2024, which is hereby incorporated by reference in its entirety.

According to the example of FIG. 1B, FE 141 further includes a read request classifier 189 (hereinafter “classifier 189”). According to the example of FIG. 1B, classifier 189 is implemented in software. However, alternative implementations are possible in which classifier 189 is implemented in hardware or as a combination of hardware and software. According to the example of FIG. 1B, classifier 189 may be executed on one or more of the storage processors 102.

The classifier 189 may include at least one of: (i) a machine learning model and/or (ii) a rule-based engine. In one example, the machine learning model may include a neural network, such as a feed-forward neural network (FNN). In another example, the machine learning model may include a language model, such as the bidirectional encoder model (BERT) or a generative pre-trained transformer model (GPT). In yet another example, the machine learning model may be a random forest model, a gradient boosting machine, or an autoregressive integrated moving average (ARIMA) model. It will be understood that the present disclosure is not limited to classifier 189 including any specific type of machine learning model. In some implementations, the machine learning model may be configured to receive as input a frame that contains metadata associated with a read request, and classify the frame into one of two categories. The first category may be associated with the read request being part of a sequential read pattern, and the second category may be associated with the read request being part of a random pattern. Under the nomenclature of the present disclosure, when the read request is part of a sequential read pattern, the read request is said to be a sequential read request, and when the read request is part of a random pattern, the read request is said to be a random read request. Stated succinctly, the machine learning model may be configured to receive at least some of the metadata of a read request and determine (or detect) whether the read request is sequential or random.

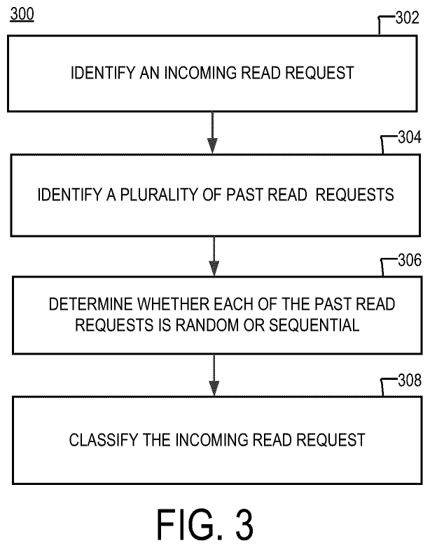

The rule-based engine may be configured to receive, as input, metadata that is associated with a read request and execute, based on the metadata, one or more rules for determining whether the read request is sequential or random. An example of a process that can be executed by classifier 189, when classifier 189 is implemented by using a rule-based engine, is discussed further below with respect to FIG. 3. It will be understood that the present disclosure is not limited to any specific implementation of classifier 189.

In some implementations, a read request may be considered sequential if the read request is part of a plurality of read requests attempting to retrieve data from a set of contiguous (or nearly-contiguous addresses). Additionally or alternatively, a read request may be considered to be sequential if the read request is part of a plurality of read requests that are received during a particular time window, such that: (i) each of the read requests attempts to read data from a corresponding one of a plurality of logical memory addresses, and (ii) for each of the plurality of logical memory addresses there exists another memory address that is part of the plurality that is either consecutive with the former logical memory address or spaced apart from a predetermined number of the former logical memory addresses by no more than a predetermined distance (e.g., 5 or 6 places, etc.). Those of ordinary skill in the art will readily recognize, after reading the present disclosure, what it means for a read request to be sequential. In this regard, it will be understood that the present disclosure is not limited to any specific definition of “sequentiality” as this term pertains to read requests.

In some implementations, a read request may be considered random if the read request is not sequential. Additionally or alternatively, a read request may be considered random if the read request is not part of a plurality of read requests that are attempting to retrieve data from a set of contiguous (or nearly contiguous addresses). Additionally or alternatively, a read request may be considered to be sequential if the read request is part of a plurality of read requests that are received during a particular time window, such that: (i) each of the read requests attempts to read data from a corresponding one of a plurality of logical memory addresses, and (ii) the logical address of the read request is spaced apart from each of the logical addresses of the other read requests in the plurality by more than a predetermined distance (e.g., 5 or 6 places, etc.). Those of ordinary skill in the art will readily recognize, after reading the present disclosure, what it means for a read request to be “random”. In this regard, it will be understood that the present disclosure is not limited to any specific definition of “randomness” as this term pertains to read requests. In general, a sequential read request would be part of a group of certain size that consists of read requests that are received during a same time window and which attempt to read from the same region in permanent storage, whereas a random request would not be part of such a group.

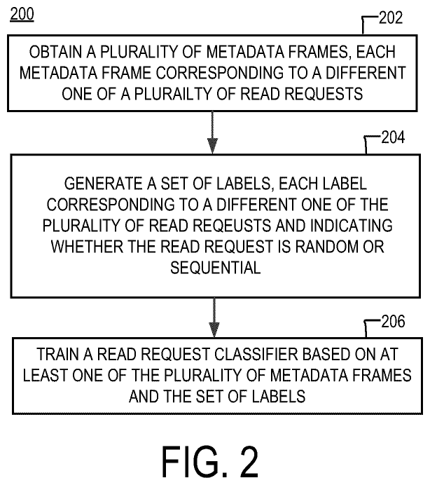

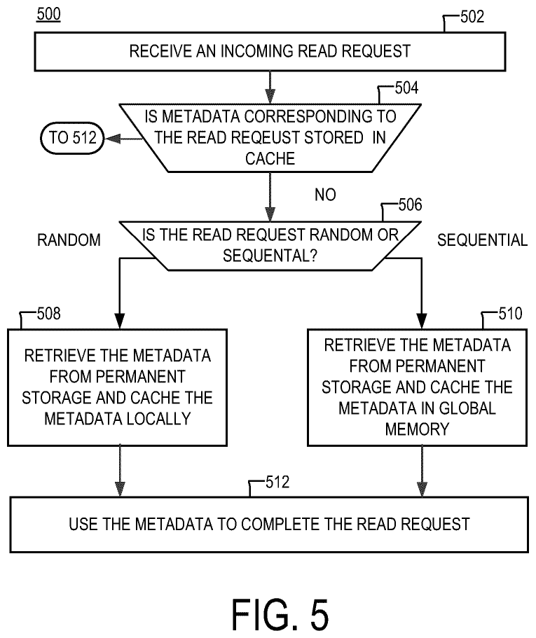

FIG. 1C shows an example of an FE track 160 and a page 164. The term “frontend track” as used throughout the disclosure refers to a data block, or a unit of data storage, in which data is cached into the GM 142. According to the present example, the FE track 160 is 128K in size and it consists of a plurality of slots that are each 16K in size. However, in an alternative implementation, the FE track 160 may have a mix of 64K and 16K slots. Stated succinctly, the present disclosure is not limited to any specific implementation of the FE track 160 and/or the slots that form the FE track 160. The term “slot” as used herein refers to a smaller unit of data storage that is part of an FE track. In general, a track may include one or more slots. Under the nomenclature of the present disclosure, the term “track” refers to a unit of data, and is not intended to imply a particular size or structure of the unit. According to the present example, page 164 includes a plurality of tracks, such as the track 160, and is 4000K in size. Each of the tracks in in page 164 may be configured in the same or similar way to FE track 160. Stated succinctly, the term “page,” as used throughout the disclosure shall refer to a collection of data blocks (or data units). According to the present example, page 164 (and FE track 160) stores metadata that is used for storing user data on RAID array 103 and/or data that is used for retrieving and/or decoding user data that is stored in RAID array 103. By way of example, the metadata may include a hash digest, an indication of a type of encoding (or compression) that is used to encode/compress the metadata's corresponding user information, and/or any other suitable information. Further examples of metadata that can be stored in page 164 (and/or FE track 160) are discussed further below with respect to step 202 of process 200 (shown in FIG. 2) and step 504 of process 500 (shown in FIG. 5).

FIG. 2 is a flowchart of an example of a process 200 for training the classifier 189 when the classifier 189 is implemented by using a machine learning model.

At step 202, a plurality of metadata frames is obtained. Each of the metadata frames corresponds to a different read request that is received at storage system 133 during a past time window. Each of the read requests is one that has been completed already. Each of the metadata frames includes one or more metadata items that are associated with the metadata frame's corresponding read request. By way of example, a metadata frame may include one or more of the logical block address (or another memory address) from which the frame's corresponding read request is attempting to retrieve data. Additionally or alternatively, the metadata frame may include an indication of the size of the data the frame's corresponding read request is attempting to retrieve. Additionally or alternatively, the metadata frame may include an identifier (e.g., an IP address, a user name, and/or another identifier) of the sender of the frame's corresponding read request. Additionally or alternatively, the metadata frame may include an indication of the time when the frame's corresponding read request is received or transmitted. Additionally or alternatively, the metadata frame may include an indication of the load on the storage system 133 at the time when the frame's corresponding read request is received. Additionally or alternatively, the metadata frame may include an indication of the load on a logical unit from which the frame's corresponding read request attempts to read data, at the time when the frame's corresponding read request is received.

At step 204, a set of labels is generated. The set of labels may include as many labels as there are read requests or data frames in the plurality (discussed with respect to step 202). Each label in the set may correspond to a different one of the plurality of data frames. Each of the labels may indicate whether the label's corresponding read request is sequential or random. By way of example, each of the labels may be generated by examining whether the label's corresponding read request satisfies any of the conditions (discussed above with respect to FIG. 1C) to qualify as random or sequential.

At step 206, the machine learning model is trained by using the plurality of metadata frames and/or the plurality of labels. Any suitable type of supervised or unsupervised learning algorithm can be used for the training. The present disclosure is not limited to using any specific method for training the machine learning model based on a training data set that includes: (1) metadata of write requests (obtained at step 202) and/or (2) information whether the metadata corresponds to sequential or random write requests (obtained at step 204).

FIG. 3 is a flowchart of an example of a process 300 for classifying an incoming read request. Process 300 may be performed by classifier 189, when classifier 189 includes a rule-based engine.

At step 302, an incoming read request is identified. The incoming read request is a read request that is received at storage system 133, and which has not been executed yet.

At step 304, a plurality of past read requests is identified which match the incoming read request. The plurality of past read requests may include read requests that were received at storage system 133 in the past and which have already been executed. According to the present example, a given past read request matches the incoming read request when a threshold number of the following conditions is satisfied. The threshold number may be any number that is greater than or equal to 1. According to the present example, the threshold number is equal to ‘3’.
Condition #1: This condition is satisfied when the given past read request and the incoming read request have the same sender;
Condition #2: This condition is satisfied when the given past read request and the incoming read request attempt to retrieve data from the same logical unit;
Condition #3: This condition is satisfied when the given past read request and the incoming read request attempt to read the same amount of data (e.g., 16K).
Condition #4: This condition is satisfied when the distance between the respective timestamps of the incoming read request and the past read request is within a predetermined distance (e.g., 1 hour). In this example, the timestamp of a read request identifies the time when the read request is transmitted to storage system 133.
Condition #5: This condition is satisfied when the incoming and past read requests are received under similar load conditions of storage system 133 (e.g., when the loads experienced by storage system 133 are within 10% of each other).

In some implementations, a determination of whether a past read request matches an incoming read request may be performed by generating respective metadata frames for the incoming and past read requests and comparing the metadata frames. Each of the metadata frames may contain any of the information discussed above with respect to step 202 of process 200 (shown in FIG. 2). As used throughout the specification, the term “metadata frame” refers to a body of metadata that includes one or more metadata items.

At step 306, a determination is made whether each of the past read requests is sequential or random. By way of example, the determination can be made by examining whether each of the past read request satisfies any of the conditions discussed above with respect to FIG. 1C.

At step 308, the incoming read request is classified as either a sequential read request or a random read request based on the number of past read requests that are found to be sequential. For example, if a majority of the past read requests that match the incoming read request (identified at step 304) are found to be sequential, the incoming read request may be classified as a sequential read request. By contrast, if a majority of the past read requests that match the incoming read request (identified at step 304) are found to be random, the incoming read request may be classified as a random read request.

FIG. 4 is a diagram of an example of a storage processor 102, according to aspects of the disclosure. As illustrated, storage processor 102 may include a processor 402, a random-access memory (RAM) 404, and a communications interface 412. The processor 402 may include any of one or more general-purpose processors (e.g., x86 processors, RISC processors, ARM-based processors, etc.), one or more Field Programmable Gate Arrays (FPGAs), one or more application-specific circuits (ASICs), and/or any other suitable type of processing circuitry. RAM 404 may include non-volatile (RAM), a dynamic random memory (DRAM), a double data rate random-access memory (DDR RAM), and/or any other suitable type of random-access memory. According to the present example, RAM 404 includes volatile memory. However, alternative implementations are possible in which RAM 404 includes non-volatile memory. The communications interface 412 may include one or more of an InfiniBand interface, an Ethernet adapter, a Long-Term Evolution (LTE) adapter, and/or any other suitable type of interface. Although not shown in FIG. 4, storage processor 102 may include permanent storage, such as a flash drive or a hard disk. It will be understood that the present disclosure is not limited to any specific implementation of storage processor 102.

In the example of FIG. 4, RAM 404 includes portions 408 and 410. Portion 408 is dedicated to the global memory (GM) 142. Portion 408 is managed by parts of storage system 133 that are responsible for implementing GM 142. Each of the physical addresses in portion 408 may be mapped to a corresponding logical address in GM 142. As noted above, GM 142 may be used as a global cache that is shared among all of the storage processors 102 in storage system 133. In other words, portion 410 may be accessible to at least one processor in the instant storage processor (i.e., the storage processor 102 that is shown in FIG. 4), as well as other storage processors in the storage system 110. Portion 410, on the other hand, may be dedicated to use for local caching. In other words, portion 410 may be used for local caching by the instant storage processor 102 (i.e., the storage processor shown in FIG. 4), but it may be inaccessible by the other storage processors 102 that are part of storage system 133.

FIG. 4 is provided as an example only. For instance, portion 408 may be accessible to all processors (e.g., CPUs or CPU cores) in the instant storage processor 102 or by only one of the CPUs or CPU cores. The concept of “global memory” of a storage system is well understood by those of ordinary skill in the art. In this regard, it will be understood that the present disclosure is not limited to any specific implementation of GM 142 and/or portion 408.

FIG. 5 is a flowchart of an example of a process 500, according to aspects of the disclosure. In the example of FIG. 5, process 500 is performed by a given one of the storage processors 102 in storage system 133. However, the present disclosure is not limited to being executed by any specific entity or set of entities.

At step 502, the given storage processor 102 receives a read request that is incoming to storage system 133. For example, the given storage processor 102 may receive the read request from a multipath agent of storage system 133, a switch that is part of storage system 133, a load balancer that is part of storage system 133, and/or any other component of storage system 133.

At step 504, the given storage processor 102 determines if metadata corresponding to the read request is cached. For example, the given storage processor 102 may determine if the metadata is stored in a local cache of the given storage processor 102 or the global memory (GM) 142. As noted above, metadata is stored in the local cache of the given storage processor 102 when the metadata is stored in portion 410 of the RAM 404 of the storage processor 102. By way of example, the metadata may include a hash digest of the data that is being requested by the read request, a table entry that maps a logical block address (LBA) contained in the read request to the hash digest, a table entry that maps the hash digest to a physical storage location in RAID array 103, and/or any other suitable type of metadata that is needed for the read request (obtained at step 502) to be executed successfully. If the metadata is found in cache, process 500 proceeds to step 512. Otherwise, if the metadata is not found in cache, process 500 proceeds to step 506.

At step 506, a determination is made if the read request is random or sequential. The determination may be made by using the classifier 189 to classify the read request. In instances in which classifier 189 is implemented by using a rule-based engine, step 506 may be implemented in accordance with process 300, which is discussed above with respect to FIG. 3. In instances, in which the classifier 189 is implemented by using a machine learning model, step 506 may be executed by: (i) generating a metadata frame for the read request, and (ii) classifying the metadata frame with machine learning model to determine if the read request is random or sequential. The metadata frame may contain any of the information that is discussed above with respect to step 202 of process 200 (shown in FIG. 2). However, the present disclosure is not limited to any specific method for detecting if a read request is sequential or random. If the read request is found to be random, process 500 proceeds to step 508. Otherwise, if the read request is found to be sequential, process 500 proceeds to step 510.

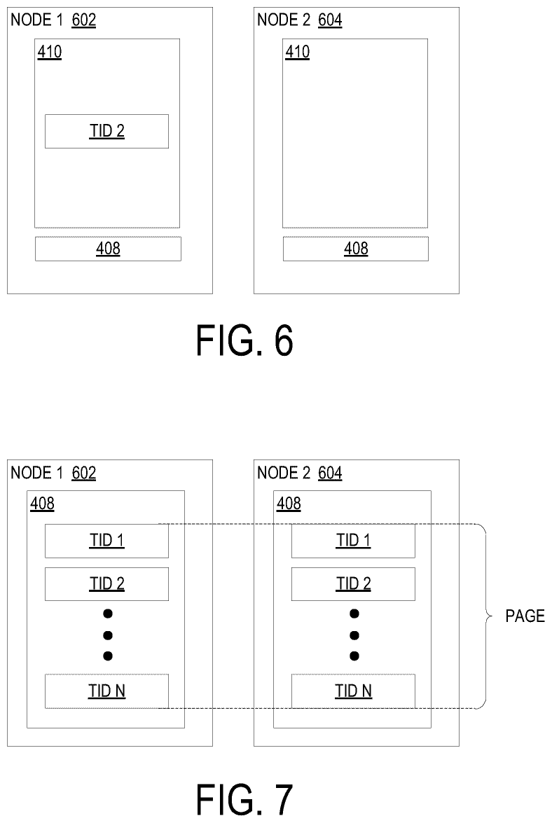

At step 508, metadata corresponding to the read request (received at step 502) is retrieved from RAID array 103 (or other permanent storage) and stored in a local cache of the given storage processor 102. The metadata that is retrieved and stored in the local cache may be the same as the metadata discussed above with respect to step 504. As noted above, the local cache of the given storage processor 102 may be a portion in the random-access memory of the given storage processor 102, such as the portion 410, which is not accessible by the other storage processors 102 in the storage system 133. However, the present disclosure is not limited to any specific method for performing local caching at the given storage processor 102. In some implementations, step 508 may be performed in the manner discussed further below with respect to FIG. 6.

At step 510, metadata corresponding to the read request (received at step 502) is retrieved from RAID array 103 (or other permanent storage) and stored in GM 142. The metadata that is retrieved and stored in GM 142 may be the same as the metadata discussed above with respect to step 504. In some implementations, storing the metadata in GM 142 may include storing the metadata in a portion of the random-access memory of the given storage processor 102, such as the portion 408, which is dedicated to being part of GM 142. Additionally or alternatively, storing the metadata in GM 142 may include storing the metadata in a similar random-access memory portion of another one of the storage processors 102. In some implementations, step 510 may be performed in the manner discussed further below with respect to FIG. 7.

At step 512, the metadata is retrieved from the location where it is cached (e.g., from local cache or GM 142), after which the metadata is used to complete the read request (received at step 502). For example, when the metadata includes a hash digest of the user data that is being attempted to be retrieved by the read request, the hash digest may be used to identify the physical location in RAID array 103 where the user is data is stored, after which the user data may be retrieved from the physical location and returned to the sender of the read request.

FIGS. 6-7 are schematic diagrams illustrating the difference between storing the metadata in local cache (at step 508) and storing the metadata in GM 142 (at step 510).

FIG. 6 is a schematic diagram illustrating the manner in which step 508 may be performed in some implementations. FIG. 7 is a schematic diagram illustrating how step 510 may be performed in some implementations. Shown in FIGS. 6 and 7 are nodes 602 and 604. Node 604 is the given storage processor 102 which executes process 500—i.e., in the example of FIGS. 6-7 node 604 is the storage processor that executes the process 500. Node 606, is another storage processor 102 in storage system 133. In the example of FIGS. 6-7, both of nodes 602 and 604 are configured in the manner discussed above with respect to FIG. 4. In this regard, each of nodes 602 and 604 includes a random-access memory portion 410 that is used to implement GM 142, and a random-access memory portion 408 that is used for local caching.

FIG. 6 illustrates that step 508 may be performed as follows: First, a data chunk is identified that is stored in RAID array 103 and includes the metadata (discussed with respect to step 504). The data chunk may have the same size as a frontend track (e.g., FE track 160, shown in FIG. 1C). Next, the data chunk may be retrieved from RAID array 103. And finally, the data chunk is stored in an FE track that is allocated in portion 410 of the random-access memory of node 602. In the example of FIG. 6, when the metadata is stored in portion 410, no other nodes or storage processors that are part of storage system 133 can access the metadata.

FIG. 7 illustrates that step 510 may be performed as follows: First, a data chunk is identified that is stored in RAID array 103 and includes the metadata (discussed with respect to step 504). The data chunk may have the same size as a page (e.g., page 164, shown in FIG. 1C). Next, the data chunk may be retrieved from RAID array 103. Next, the data chunk may be stored in a page that is allocated in portion 408 of the random-access memory of node 602. And finally, the data chunk is stored in a page that is allocated portion 408 of the random-access memory of node 604. In other words, in the example of FIG. 7 the retrieved metadata is mirrored to one additional memory location (in addition to being stored in the memory of node 602). Furthermore, the page that is brought into the memory of node 602 (and node 604) may include a plurality of tracks, as is discussed in the example of FIG. 1C. One of the plurality of tracks may be the track that is brought into the memory of node 602, in the example of FIG. 6 (i.e., the track having the track id (TID) of ‘2’).

Together FIGS. 6-7 illustrate that step 508 of process 500 involves fetching a smaller amount of data than step 510. Furthermore, FIGS. 6-7 illustrate that step 510 involves data mirroring—i.e., the storage of the metadata on multiple nodes, whereas step 508 does not.

In some respects, process 500 is an example of a process in which metadata for random read requests is cached locally, whereas the metadata for sequential read requests is cached in the global memory (GM 142) of storage system 133. Furthermore, in process 500, only a single track is cached for random read requests, whereas, for sequential read requests, an entire page is cached. This is in contrast to conventional storage systems, where an entire page of metadata is brought into global memory irrespective of whether a read request is sequential or random.

In some respects, process 500 is advantageous because it is more efficient than the conventional approach. As noted above, the conventional approach involves bringing into global memory an entire page of metadata irrespective of whether a read request is random or sequential. However, this is inefficient when a read request is random because the other metadata in the page is unlikely to be useful for executing subsequent read requests. Moreover, such metadata (which is not going to be used) occupies valuable global memory space which could be put to other more productive uses. By contrast, to execute a random read request, process 500 copies a much smaller amount of data (e.g., a track as opposed to a page), and this data is stored in s local cache instead of the global memory, which conserves space in the global memory (e.g., GM 142). In other words, process 500 is advantageous over the conventional approach because it requires fewer system resources for the execution of random read requests.

In the example of FIGS. 6-7, each of nodes 602 and 604 may be a separate storage processor. As used herein, the term “storage processor” may refer to any suitable type of computing device. An example of one possible configuration of a storage processor is shown in FIG. 4. In some implementations a storage processor may include a single processor (e.g., CPU) that is mounted on a motherboard together random-access memory module(s) (and other hardware). Additionally, or alternatively, a storage processor may include a pair of processors (e.g., multi-core central processing units (CPUs)) that are mounted on a motherboard together with memory module(s) and other hardware. Alternatively, in some implementations, each of nodes 602 and 604 may be a portion of a storage processor. For example, when a storage processor includes two CPU that are mounted on a motherboard together with RAM module(s) (and other hardware), node 602 may the first CPU and a portion of the RAM that has been allocated for use by the first CPU; and node 604 may include the second CPU and a portion of the RAM that is allocated for use by the second CPU. Stated succinctly, the present disclosure is not limited to any specific implementation of nodes 602 and 604. In the example of FIGS. 6-7, storage system 133 is a content-addressable storage system, however alternative implementations are possible in which storage system 133 is a location-addressable storage system and/or any other suitable type of storage system. In the example of FIG. 4, memory portion 410 is allocated in the random-access memory of the storage processor 102. However, alternative implementations are possible in which memory portion 410 is allocated (fully or partially) in a permanent storage of the storage processor 102 (such as a hard disk (HD) or a solid state drive (SSD)). Although, in the example of FIG. 5, process 500 is described as being executed by a storage processor 102, alternative implementations are possible in which process 500 is executed by a portion of a storage processor (e.g., by a specific central processing unit (CPU) in the storage processor using the RAM that is allocated to the CPU).

FIGS. 1-7 are provided as an example only. In some embodiments, the term “I/O request” or simply “I/O” may be used to refer to an input or output request. At least some of the steps discussed with respect to FIGS. 1-5 may be performed in a different order or altogether omitted. As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. The acronym RAID, as used throughout the disclosure, means “Redundant Array of Independent Disks”.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method for use in a storage system including a plurality of nodes, the method comprising:
receiving, at a given one of the plurality of nodes, a read request;
classifying the read request as either a random read request or a sequential read request;
when the read request is classified as a random read request, storing a given track that includes first metadata associated with the read request in a local cache of the given node;
when the read request is classified as a sequential read request, storing a page that includes the first metadata in a global memory of the storage system, the page including a plurality of tracks, the plurality of tracks including the given track; and
retrieving the first metadata from the local cache or the global memory of the storage system, and using the first metadata to complete the read request,
wherein the local cache of the given node is implemented by using a physical memory hardware of the given node, and
wherein the global memory includes a plurality of global memory portions that are part of a same address space, each global memory portion being implemented by using physical memory hardware that is part of a different one of the plurality of nodes in the storage system.

2. The method of claim 1, wherein the first metadata includes a hash digest of user data that is being attempted to be retrieved by the read request.

3. The method of claim 1, wherein each of the plurality of nodes includes a different storage processor of the storage system.

4. The method of claim 1, wherein each of the plurality of nodes includes a respective storage processor portion.

5. The method of claim 1, wherein a first portion of the physical memory hardware of the given node is designated for use as a local cache and a second portion of the physical memory hardware of the given node is designated for use as part of the global memory.

6. The method of claim 1, wherein the classifying is performed by using a read request classifier, the read request classifier being configured to receive, as input, a second metadata associated with the read request and output an indication of whether the read request is random or sequential.

7. The method of claim 1, wherein the given track or the page is retrieved from a redundant array of independent disks (RAID) array that is part of the storage system.

8. A storage processor, comprising:
a physical memory hardware; and
at least one processor that is operatively coupled to the physical memory hardware, the at least one processor being configured to perform the operations of:
receiving a read request;
classifying the read request as either a random read request or a sequential read request;
when the read request is classified as a random read request, storing a given track that includes first metadata associated with the read request in a local cache;
when the read request is classified as a sequential read request, storing a page that includes the first metadata in a global memory of a storage system, the page including a plurality of tracks, the plurality of tracks including the given track; and
retrieving the first metadata from the local cache or the global memory, and using the first metadata to complete the read request,
wherein the local cache is implemented by using the physical memory hardware, and
wherein the global memory includes a plurality of global memory portions that are part of a same address space, each global memory portion being implemented by using physical memory hardware that is part of a different one of a plurality of storage processors in the storage system.

9. The storage processor of claim 8, wherein the first metadata includes a hash digest of user data that is being attempted to be retrieved by the read request.

10. The storage processor of claim 8, wherein the storage processor is part of the storage system, and the plurality of storage processors includes the storage processor.

11. The storage processor of claim 8, wherein a first portion of the physical memory hardware is designated for use as a local cache and a second portion of the physical memory hardware of is designated for use as part of the global memory.

12. The storage processor of claim 8, wherein the classifying is performed by using a read request classifier, the read request classifier being configured to receive, as input, a second metadata associated with the read request and output an indication of whether the read request is random or sequential.

13. The storage processor of claim 12, wherein the read request classifier is implemented by using at least one of a machine learning model and a rule-based engine.

14. The storage processor of claim 8, wherein the given track or the page is retrieved from a redundant array of independent disks (RAID) array that is part of the storage system.

15. A non-transitory computer-readable medium storing one or more process-executable instructions, which when executed by at least one processor of a of a given node cause the given node to perform the operations of:
receiving a read request;
classifying the read request as either a random read request or a sequential read request;
when the read request is classified as a random read request, storing a given track that includes first metadata associated with the read request in a local cache of the given node;
when the read request is classified as a sequential read request, storing a page that includes the first metadata in a global memory of a storage system of which the given node is part, the page including a plurality of tracks, the plurality of tracks including the given track; and
retrieving the first metadata from the local cache or the global memory of the storage system, and using the first metadata to complete the read request,
wherein the local cache of the given node is implemented by using a physical memory hardware of the given node, and
wherein the global memory includes a plurality of global memory portions that are part of a same address space, each global memory portion being implemented by using physical memory hardware that is part of a different one of a plurality of nodes in the storage system, the plurality of nodes including the given node.

16. The non-transitory computer-readable medium of claim 15, wherein the first metadata includes a hash digest of user data that is being attempted to be retrieved by the read request.

17. The non-transitory computer-readable medium of claim 15, wherein each of the plurality of nodes includes a different storage processor of the storage system.

18. The non-transitory computer-readable medium of claim 15, wherein each of the plurality of nodes includes a respective storage processor portion.

19. The non-transitory computer-readable medium of claim 15, wherein a first portion of the physical memory hardware of the given node is designated for use as a local cache and a second portion of the physical memory hardware of the given node is designated for use as part of the global memory.

20. The non-transitory computer-readable medium of claim 15, wherein the classifying is performed by using a read request classifier, the read request classifier being configured to receive, as input, a second metadata associated with the read request and output an indication of whether the read request is random or sequential.
